(19) United States
(12) Patent Application Publication
(10) Pub. No.: US 2018/0356937 A1
(43) Pub. Date: Dec. 13, 2018

(54) PROJECTION TOUCH SYSTEM AND CORRECTION METHOD THEREOF

(71) Applicant: Coretronic Corporation, Hsin-Chu (TW)

(72) Inventors: Cheng-Shen Lee, Hsin-Chu (TW); Chih-Neng Tseng, Hsin-Chu (TW)

(73) Assignee: Coretronic Corporation, Hsin-Chu (TW)

(21) Appl. No.: 16/003,123

(22) Filed: Jun. 8, 2018

(30) Foreign Application Priority Data
Jun. 13, 2017 (CN) 201710441822.7

(51) Int. Cl. G06F 3/041

(52) U.S. Cl. CPC G06F 3/0418

(57) ABSTRACT

A projection touch system including a processing device, a touch film, a projection device and an image capturing device is provided. The projection device projects a first correction image to the touch film. The touch film generates a touch signal in response to a touch operation performed by a touch object touching the touch film according to the first correction image. The processing device generates a first coordinate transformation equation according to the first correction image and the touch signal. The image capturing device captures a first image frame of the touch film. The processing device analyzes the first image frame to establish a second coordinate transformation equation, and establishes a third coordinate transformation equation according to the first coordinate transformation equation and the second coordinate transformation equation. A correction method adapted to the projection touch system is also provided.

### CROSS-REFERENCE TO RELATED APPLICATION

This application claims the priority benefit of China application serial no. 201710441822.7, filed on Jun. 13, 2017. The entirety of the above-mentioned patent application is hereby incorporated by reference herein and made a part of this specification.

### BACKGROUND OF THE INVENTION

### Field of the Invention

The invention relates to a correction technique, and particularly relates to a projection touch system and a correction method thereof.

### Description of Related Art

Generally, when a projector projects an image frame on a projection surface, coordinates between the projector and the projection surface are required to be manually corrected such that a projection image may present a correct projection position on the projection surface. However, in the present technical field of the projector, more and more projectors are used for projecting projection images on the projection surface, where the projection surface is a non-planar surface. However, the conventional projector design needs to be manually adjusted by the user. Moreover, if the projection surface is further designed as a touch film having a touch function, the coordinate correction operation between the projector and the touch film requires a complicated correction procedure. For example, if the touch film is attached to a curved surface, the projector has to projector correction targets of more than a hundred points, and the user has to touch or click the correction targets one-by-one in a manual manner in order to simulate a real curvature of the curved surface. Therefore, how to accurately and effectively perform the coordinate correction operation on the projector and the touch film attached to the non-planar surface is one of the most important issues in the field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention is directed to a projection touch system and a correction method thereof, by which a projection and touch operation may be performed to a touch film attached to a plane or a non-planar surface, and a multi-point correction operation may be accurately and efficiently performed to improve a touch accuracy of the touch film.

In order to achieve one or a portion of or all of the objects or other objects, an embodiment of the invention provides a projection touch system. The projection touch system includes a processing device, a touch film, a projection device and an image capturing device. The touch film is coupled to the processing device. The projection device is coupled to the processing device. The projection device is configured to project a first correction image to the touch film. The touch film generates a touch signal in response to a touch operation performed by a touch object touching the touch film according to the first correction image. The image capturing device is coupled to the processing device. The image capturing device is configured to capture a first image frame on the touch film. The processing device generates a first coordinate transformation equation according to the first correction image and the touch signal. The processing device analyzes the first image frame to establish a second coordinate transformation equation. The processing device establishes a third coordinate transformation equation according to the first coordinate transformation equation and the second coordinate transformation equation.

In order to achieve one or a portion of or all of the objects or other objects, an embodiment of the invention provides a correction method adapted to a projection touch system. The projection touch system includes a touch film, a projection device and an image capturing device. The correction method includes: projecting a first correction image to the touch film by using the projection device; generating a touch signal by the touch film in response to a touch operation performed by a touch object touching the touch film according to the first correction image; establishing a first coordinate transformation equation according to the first correction image and the touch signal; capturing a first image frame of the touch film by the image capturing device, and analyzing the first image frame to establish a second coordinate transformation equation; and establishing a third coordinate transformation equation according to the first coordinate transformation equation and the second coordinate transformation equation.

According to the above description, the embodiments of the invention have at least one of the following advantages and effects. The projection touch system and the correction method of the invention may respectively establish the first coordinate transformation equation, the second coordinate transformation equation and the third coordinate transformation equation between the touch film, the projection device and the image capturing device, such that the projection touch system may adopt these coordinate transformation equations to perform accurate and efficient multi-point correction operation to the touch film, so as to improve the touch accuracy of the touch film.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection touch system according to an embodiment of the invention.

FIG. 2 is a schematic diagram of a projection touch system according to another embodiment of the invention.

FIG. 3 is a side view of the projection touch system of the embodiment of FIG. 1.

FIG. 4 is a schematic diagram of a first correction image according to an embodiment of the invention.

FIG. 5 is a schematic diagram of a second correction image according to an embodiment of the invention.

FIG. 6 is a flowchart illustrating a correction method according to an embodiment of the invention.

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

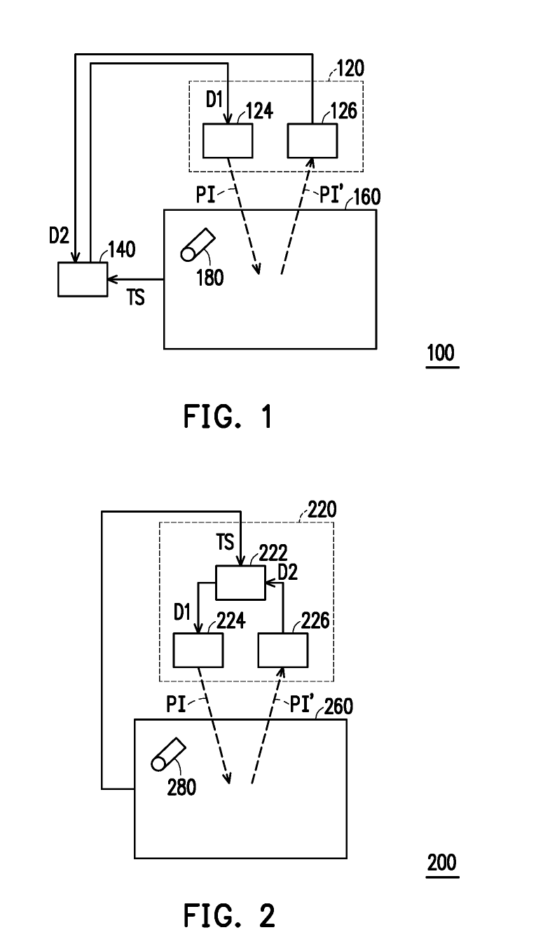

FIG. 1 is a schematic diagram of a projection touch system according to an embodiment of the invention. Referring to FIG. 1, in the embodiment, the projection touch system 100 includes a projection system 120, a processing device 140 and a touch film 160. The projection system 120 includes a projection device 124 and an image capturing device 126. In the embodiment, the processing device 140 is disposed outside the projection system 120, and is coupled to the projection device 124 and the image capturing device 126, and the coupling method thereof is a wired or wireless way for transmitting information. In the embodiment, the processing device 140 provides image data D1 to the projection device 124, and the projection device 124 projects an image frame PI on a projection surface of the touch film 160 according to the image data D1, where the image frame PI is formed by an image beam projected by the projection device 124. Moreover, the image capturing device 126 is configured to capture the image beam reflected by the image frame PI formed on the projection surface of the touch film 160, and the reflected image beam captured by the image capturing device 126 is defined as a captured image frame PI′. In the embodiment, the image capturing device 126 may obtain image data D2 according to the captured image frame PI′, and transmit the image data D2 to the processing device 140. In the embodiment, the processing device 140 may be disposed outside the projection system 120. The processing device 140 is, for example, a central processing unit (CPU) having an image data processing function and a computation function, or other programmable general purpose or special purpose microprocessor, a digital signal processor (DSP), an image processing unit (IPU), a graphics processing unit (GPU), a programmable controller, an application specific integrated circuits (ASIC), a programmable logic device (PLD), other similar processing device or a combination of the above devices. Moreover, the processing device 140 may further include a storage device, where the storage device may be used for storing image processing programs, image data, data computation programs or coordinate transformation equations, etc. of the embodiments of the invention, and the processing device 140 may execute/perform these programs, data and the coordinate transformation equations to implement the projection touch system and the correction method thereof described in the embodiments of the invention. In another embodiment, the processing device 140 can also be configured in a desktop computer, a personal computer (PC), a portable terminal product, a personal digital assistor (PDA), a tablet PC, etc.

In the embodiment, the image capturing device 126, for example, includes a charge coupled device (CCD) image sensor or a complementary metal oxide semiconductor (CMOS) image sensor, etc. Moreover, the projection device 124 may be a projector, and the projector has a light modulator, for example, a reflective or transmissive spatial light modulator. The reflective spatial light modulator is, for example, reflective liquid crystal on silicon (LCOS) or digital micro-mirror device (DMD), etc., and the transmissive spatial light modulator is, for example, a transparent liquid crystal panel. Moreover, based on different methods for inputting a control signal, the light modulator is, for example, an optically addressed spatial light modulator (OASLM) or an electrically addressed spatial light modulator (EASLM), and the patterns and types of the light modulator are not limited by the invention.

Referring to FIG. 1, in the embodiment, the touch film 160 has a flexible feature, so that the touch film 160 may be attached on a planar or non-planar surface. The touch film 160 is, for example, a capacitive touch film applying a projected capacitive touch (PCT) technique or a resistive touch film, though the invention is not limited thereto. In an embodiment applying the capacitive touch film, the touch film 160 has a touch surface and a projection surface. The touch surface of the touch film 160 may be formed by a plurality of metal lines arranged in a grid form, and the touch surface of the touch film 160 may be used for sensing a touch result of a touch object 180 on the touch film 160 to generate a corresponding touch signal TS, and as the touch film 160 is coupled to the processing device 140, the touch signal is transmitted to the processing device 140. In the embodiment, in case of a general touch operation, the projection device 124 projects an image beam to form the image frame PI on the projection surface of the touch film 160, and the user may view the image frame PI on the touch film 160, and meanwhile performs a touch operation according to the image frame projected on the touch film 160. The projection surface of the touch film 160 is a region of the image frame PI formed on the touch film 160, where the image frame PI is formed by the image beam projected by the projection device 124, and a range of such region is smaller than a range of the touch surface of the touch film 160.

Moreover, in the embodiment, the touch object 180 is, for example, a finger of the user or a capacitive touch pen.

FIG. 2 is a schematic diagram of a projection touch system according to another embodiment of the invention. Referring to FIG. 2, in the embodiment, the projection touch system 200 includes a projection system 220 and a touch film 260. The projection system 220 includes a processing device 222, a projection device 224 and an image capturing device 226. In the embodiment, the processing device 222 is configured in the projection system 220, and is adapted to receive image data provided by an external image source, and the processing device 222 is coupled to the projection device 224 and the image capturing device 226. In the embodiment, the processing device 220 provides image data D1 to the projection device 224, and the projection device 224 projects the image frame PI on the projection surface of the touch film 260 according to the image data D1. Moreover, the image capturing device 226 is configured to capture the image frame formed on the touch film 260 to obtain the captured image frame PI′. In the embodiment, the image capturing device 226 obtain the image data D2 according to the captured image frame PI′, and transmit the image data D2 to the processing device 140. The processing device 140 receives the image data D2 from the image capturing device 226.

Compared to the embodiment of FIG. 1, the processing device 222 of the embodiment is configured in the projection system 220. Namely, the projection system 220 of the embodiment has the image data processing function and computation function, and is used as a projector. The projection system 220 may receive the touch signal TS generated by a touch object 280 by performing a touch operation on the touch film 260. Meanwhile, the projection device 224 of the projection system 220 projects the image frame PI, and the image capturing device 226 of the projection system 220 captures the captured image frame PI′. Moreover, the projection system 220 may further include a storage device, where the storage device may be used for storing an image processing module, image data, a data computation module or image data, etc., and the processing device 220 may execute these modules and data to implement the projection touch system and the correction method thereof described in the embodiments of the invention. However, enough instructions and recommendations for other device features of the embodiment may be learned from the embodiment of FIG. 1, and details thereof are not repeated.

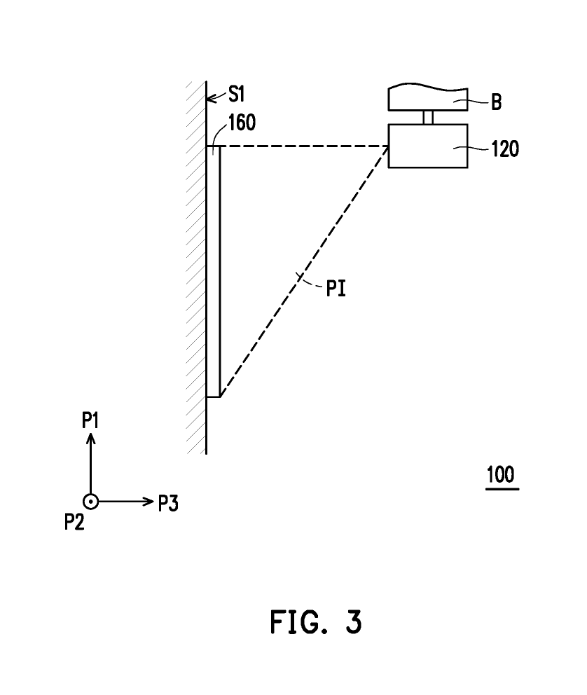

FIG. 3 is a side view of the projection touch system of the embodiment of FIG. 1. Referring to FIG. 1 and FIG. 3, in the embodiment, the projection system 120 can be installed on a fixed object B, such that the projection device 124 may project the image frame PI to the touch film 160 in a fixed angle. The touch film 160 can be attached on a surface S1, where the surface S1 may be extended on a plane formed by a first direction P1 and a second direction P2. In the embodiment, the fixed object B may be extended on a plane formed by the second direction P2 and a third direction P3, and the fixed object B is, for example, a ceiling or a support member, etc., which is not limited by the invention. In other embodiments, the projection system 120 can be disposed on a desktop, etc. The first direction P1, the second direction P2 and the third direction P3 are perpendicular to each other.

In the embodiment, if the touch film 160 is attached on the non-planar surface S1, for example, the surface S1 is a curved surface, which is a regular curved surface or an irregular curved surface, where a radius of curvature of the curved surface is adopted to define whether the curved surface is the regular curved surface or the irregular curved surface, the image projected by the projection device 124 of the projection system 120 on the touch film 160 may have an image shift or image distortion phenomenon. Moreover, a result that the user performs the touch operation on the touch film 160 based on the image frame PI projected on the touch film 160 is also shifted, which causes an inconvenience and error result in usage of the projection touch system 100. Therefore, the projection touch system 100 of the embodiment establishes coordinate transformation equations among the projection device 124, the image capturing device 126 and the touch film 160 to resolve the above problem.

It should be noted that taking the coordinate transformation between the projection device 124 and the touch film 160 as an example, the processing device 140 provides the image data D1 to the projection device 124, and the projection device 124 projects the image frame PI. In this embodiment, the image frame PI may have four correction targets, and the four correction targets may respectively have coordinates of (0,0), (1,0), (1,1) and (0,1). In other embodiments, the number of the correction targets is not limited. In the embodiment, since the touch film 160 may be attached on the non-planar surface S1, a projection result of the image frame PI on the touch film 160 is probably shifted. Namely, the displayed four correction targets may be distributed in regions of different planes of the touch film 160. In the embodiment, the user views positions of the four correction targets projected by the projection device 124, and sequentially touches the positions of the four correction targets on the touch film 160 by using the touch object 180, so as to obtain coordinates (X₀,Y₀), (X₁,Y₁), (X₂,Y₂) and (X₃,Y₃) of the four correction targets on the touch film 160, i.e. the touch signal TS, and the touch film 160 provides the touch signal TS to the processing device 140. In this way, the processing device 140 may establish following equations (1)-(5) according to the coordinates of the four correction targets of the image frame PI in the processing device and the coordinates of the four correction targets obtained by the touch film 160:

$$\begin{matrix}M = [ \begin{matrix}a & d & 0 & g \\ b & e & 0 & h \\ 0 & 0 & 1 & 0 \\ c & f & 0 & 1\end{matrix} ] & equation ( 1 ) \\ [ \begin{matrix}{X}_{0} & {Y}_{0} & 0 & 1\end{matrix} ] = [ \begin{matrix}0 & 0 & 0 & 1\end{matrix} ] \times M & equation ( 2 ) \\ [ \begin{matrix}{X}_{1} & {Y}_{1} & 0 & 1\end{matrix} ] = [ \begin{matrix}1 & 0 & 0 & 1\end{matrix} ] \times M & equation ( 3 ) \\ [ \begin{matrix}{X}_{2} & {Y}_{2} & 0 & 1\end{matrix} ] = [ \begin{matrix}1 & 1 & 0 & 1\end{matrix} ] \times M & equation ( 4 ) \\ [ \begin{matrix}{X}_{3} & {Y}_{3} & 0 & 1\end{matrix} ] = [ \begin{matrix}0 & 1 & 0 & 1\end{matrix} ] \times M & equation ( 5 )\end{matrix}$$

In the above equations (1)-(5), the symbol M represents a homogeneous transformation matrix, the symbols a-h are parameters. According to the above equation (1), it is known that the transformation matrix M may translate the coordinates (0,0), (1,0), (1,1) and (0,1) into coordinates (X₀,Y₀), (X₁,Y₁), (X₂,Y₂) and (X₃,Y₃), and it is assumed that a length and a width of the projection region of the touch film 160 are all 1. In this embodiment, the processing device 140 may calculate the above equations (1)-(5) to obtain inversed transformation matrices. The inversed transformation matrices and the transformation equations may be following equations (6)-(10):

$$\begin{matrix}{M}^{- 1} = [ \begin{matrix}A & D & 0 & G \\ B & E & 0 & H \\ 0 & 0 & 1 & 0 \\ C & F & 0 & I\end{matrix} ] & equation ( 6 ) \\ [ \begin{matrix}{X}_{0} & {Y}_{0} & 0 & 1\end{matrix} ] \times {M}^{- 1} = [ \begin{matrix}0 & 0 & 0 & 1\end{matrix} ] & equation ( 7 ) \\ [ \begin{matrix}{X}_{1} & {Y}_{1} & 0 & 1\end{matrix} ] \times {M}^{- 1} = [ \begin{matrix}1 & 0 & 0 & 1\end{matrix} ] & equation ( 8 ) \\ [ \begin{matrix}{X}_{2} & {Y}_{2} & 0 & 1\end{matrix} ] \times {M}^{- 1} = [ \begin{matrix}1 & 1 & 0 & 1\end{matrix} ] & equation ( 9 ) \\ [ \begin{matrix}{X}_{3} & {Y}_{3} & 0 & 1\end{matrix} ] \times {M}^{- 1} = [ \begin{matrix}0 & 1 & 0 & 1\end{matrix} ] & equation ( 10 )\end{matrix}$$

In the above equations (6)-(10), the symbol M⁻¹ represents an inversed transformation matrix, the symbols A-I are parameters. The processing device 140 may calculate the parameters a-h of the equations (1)-(5) to obtain the corresponding parameters A-I. Namely, the processing device 140 may correct the coordinates (X₀,Y₀), (X₁,Y₁), (X₂,Y₂) and (X₃,Y₃) of the touch positions of each of the correction targets of the touch film 160 according to the inversed transformation matrix M⁻¹. To be specific, the processing device 140 may obtain the parameters A-I through computation of the parameters a-h according to the above equations (1)-(10), so as to establish a coordinate transformation equation, which is shown as a following equation (11):

[XY01]×M⁻¹=[xy01] equation (11)

In the above equation (11), the symbol x and the symbol y represent corrected coordinates. Namely, a correction operation may be performed to the coordinates (X,Y) of each point on the touch film 160 through the above equation (11), so as to correct the coordinates (X,Y) of each point on the touch film 160 into correct coordinates (xy).

However, in another embodiment, it is assumed that the length and the width of the projection region of the touch film 160 are all r, the processing device 140 may further multiply the above inversed transformation matrix M⁻¹ by a four order matrix with a proportional constant of r. The inversed transformation matrix and the transformation equations are shown as following equations (12)-(16):

$$\begin{matrix}MA = {M}^{- 1} \times [ \begin{matrix}r & 0 & 0 & 0 \\ 0 & r & 0 & 0 \\ 0 & 0 & 1 & 0 \\ 0 & 0 & 0 & 1\end{matrix} ] = [ \begin{matrix}A & D & 0 & G \\ B & E & 0 & H \\ 0 & 0 & 1 & 0 \\ C & F & 0 & I\end{matrix} ] \times [ \begin{matrix}r & 0 & 0 & 0 \\ 0 & r & 0 & 0 \\ 0 & 0 & 1 & 0 \\ 0 & 0 & 0 & 1\end{matrix} ] & equation ( 12 ) \\ [ \begin{matrix}{X}_{0} & {Y}_{0} & 0 & 1\end{matrix} ] \times MA = [ \begin{matrix}0 & 0 & 0 & 1\end{matrix} ] & equation ( 13 ) \\ [ \begin{matrix}{X}_{1} & {Y}_{1} & 0 & 1\end{matrix} ] \times MA = [ \begin{matrix}1 & 0 & 0 & 1\end{matrix} ] & equation ( 14 ) \\ [ \begin{matrix}{X}_{2} & {Y}_{2} & 0 & 1\end{matrix} ] \times MA = [ \begin{matrix}1 & 1 & 0 & 1\end{matrix} ] & equation ( 15 ) \\ [ \begin{matrix}{X}_{3} & {Y}_{3} & 0 & 1\end{matrix} ] \times MA = [ \begin{matrix}0 & 1 & 0 & 1\end{matrix} ] & equation ( 16 )\end{matrix}$$

In the above equations (12)-(16), the symbol MA represents another inversed transformation matrix, and the another inversed transformation matrix MA is obtained by multiplying the inversed transformation matrix M⁻¹ by a four order matrix with a proportional constant of r. Therefore, the processing device 140 may correct the coordinates (X₀,Y₀), (X₁,Y₁), (X₂,Y₂) and (X₃,Y₃) of the original touch positions of each of the correction targets of the touch film 160 according to the inversed transformation matrix MA, and meanwhile correct proportions of distances between the correction targets or proportions of ranges encircled by the correction targets. To be specific, the processing device 140 may obtain the parameters A-I through computation of the parameters a-h according to the above equations (1)-(16), so as to establish another coordinate transformation equation, which is shown as a following equation (17):

[XY01]×MA=[xy01] equation(17)

In the above equation (17), the symbol x and the symbol y represent the corrected coordinates. Namely, a correction operation may be performed to the coordinates (X,Y) of each point on the touch film 160 through the above equation (17), so as to correct the coordinates (X,Y) of each point on the touch film 160 into correct coordinates (xy), and meanwhile correct proportions of the distances between the coordinates (X,Y) of each point on the touch film 160.

It should be noted that the number of the correct targets of the invention is not limited by the invention, and the coordinate correction operation between the projection device and the image capturing device of each embodiment of the invention, and the coordinate transformation equation between the touch film and the image capturing device may all be implemented with reference of the operation method of the aforementioned established equations (1)-(17). However, enough instructions and recommendations for the matrix operation method and parameter operation method between the aforementioned transformation matrices and the inversed transformation matrices may be learned from ordinary knowledge of the field, and details thereof are not repeated. Moreover, to fully convey the spirit of the correction method and the projection touch system of the invention to those skilled in the art, two embodiments are provided below for further description.

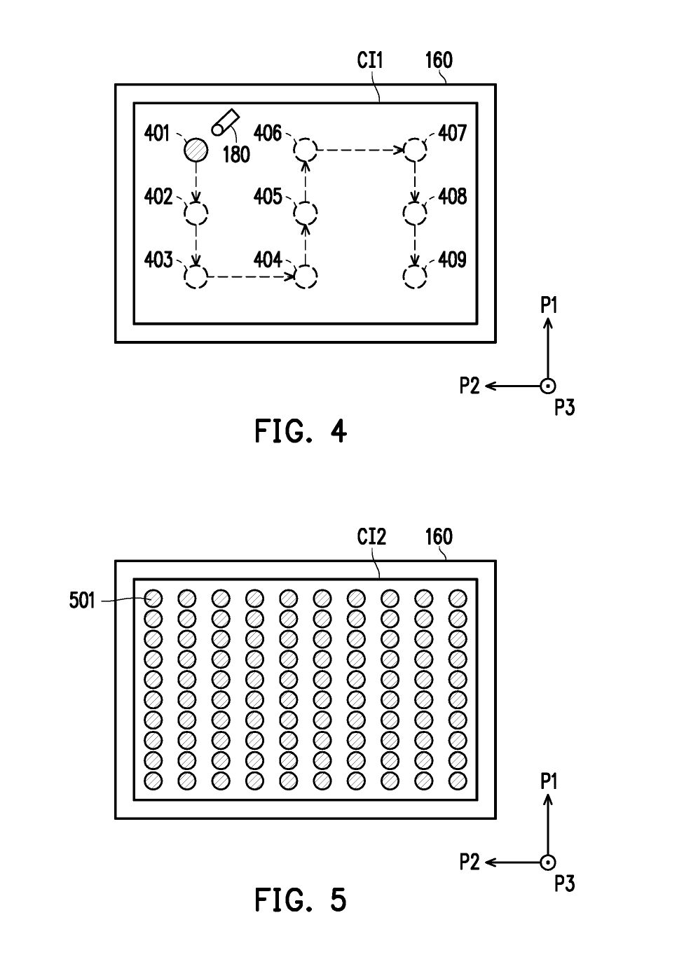

FIG. 4 is a schematic diagram of a first correction image according to an embodiment of the invention. FIG. 5 is a schematic diagram of a second correction image according to an embodiment of the invention. Referring to FIG. 1, FIG. 3, FIG. 4 and FIG. 5, in case of the correction method and the projection touch system of the invention, the touch object 180 is, for example, a touch pen with a light source, where the light source, for example, emits a visible light through a light-emitting diode (LED), or emits an infrared light through an infrared emitter, etc., which is not limited by the invention. It should be noted that the image capturing device is required to be correspondingly configured, such that the image capturing device may capture a light spot generated by the light source. In an embodiment, the projection device 124 projects the image frame PI to the touch film 160. In the embodiment, the image frame PI may present the first correction image CI1 as shown in FIG. 4, and the first correction image CI1 may include figures of 9 correction targets 401-409. In the embodiment, the touch film 160 is attached on a non-planar surface, so that the first correction targets 401-409 of the first correction image CI1 may be distributed in regions of a plurality of planes on the touch film 160.

In the embodiment, the touch film 160 performs in response to a touch operation of the touch object 180 that touches the touch film 160 according to the first correction image CI1. Namely, the user may use the touch object 180 to sequentially touch or click display positions of the correction targets 401-409 on the touch film 160, and the touch film 160 generates coordinate information to serve as the touch signal TS, where the correction targets 401-409 may be white spots or black spots, and display number, forms, positions, shapes or colors thereof are not limited by the invention. Therefore, the processing device 140 may establish a first coordinate transformation equation according to the first correction image CI1 and the coordinate information of the touch signal TS, where the first correction image CI1 is the image frame stored in the processing device 140. In the embodiment, the first coordinate transformation equation relates to coordinate transformation between the touch film 160 and the projection device 124.

In the embodiment, the object body of the touch object 180 may further include a light source, and when the touch object 180 respectively touches the positions of the first correction targets 401-409 in the first correction image CI1, the light source of the touch object 180 respectively irradiates these positions. The processing device 140 may capture images of each light spot at the positions of the first correction targets 401-409 respectively irradiated by the light source of the touch object 180 by using the image capturing device 126. In the embodiment, the processing device 140 integrates the images of the light spots to obtain the captured image frame PI′, and the processing device 140 records the captured image frame PI′ to serve as a first image frame. The first image frame may present the positions of the light spots distributed on the touch film 160. In the embodiment, the processing device 140 may analyze the first image frame to obtain coordinate information of the light spots, where a processing procedure of the analysis includes obtaining coordinate information of a substantial center position of the light spots in the first image frame, or includes omitting broken regions when the first image frame is interfered or has the broken regions, so as to accelerate the image processing. The processing device 140 may generate a second coordinate transformation equation according to the coordinate information respectively corresponding to the first image frame and the first correction image CI1. In the embodiment, the second coordinate transformation equation relates to coordinate transformation between the projection device 124 and the image capturing device 126.

In the embodiment, the processing device 140 may deduce a third coordinate transformation equation according to the first coordinate transformation equation and the second coordinate transformation equation. To be specific, since the first coordinate transformation equation relates to coordinate transformation between the touch film 160 and the projection device 124, and the second coordinate transformation equation relates to coordinate transformation between the projection device 124 and the image capturing device 126, the processing device 140 may combine or translate the first coordinate transformation equation and the second coordinate transformation equation to obtain the third coordinate transformation equation adapted to the coordinate transformation between the touch film 160 and the image capturing device 126. In the embodiment, since the touch object 180 has the light source, while the touch object 180 touches the touch film 160, the touch signal TS and the first image frame captured by the image capturing device 126 can be generated.

In the embodiment, the projection device 124 projects the projection image PI to the touch film 160, where the image frame PI may present a second correction image CI2 shown in FIG. 5. The second correction image CI2 may include figures of 100 correction targets 501, though the number of the correction targets 501 is not limited by the invention. In the embodiment, the processing device 140 may capture the second correction image CI2 projected to the touch film 160 through the image capturing device 126, so as to obtain the captured image frame PI′. The processing device 140 may record the captured image frame PI′ to serve as a second image frame. In the embodiment, the processing device 140 may analyze the second image frame to obtain coordinate information of the second correction targets 501.

Therefore, the processing device 140 of the embodiment may translate the coordinate information of the correction targets 501 through the third coordinate transformation equation, so as to obtain relative coordinate relationships of the correction targets 501 on the touch film 160. Namely, the processing device 140 of the embodiment may adopt the first coordinate transformation equation, the second coordinate transformation equation and the third coordinate transformation equation to perform a multi-point correction operation to the touch film 160. In other words, since the touch film 160 is probably attached on the non-planar surface S1, the processing device 140 may correspondingly correct the touch region of the touch film 160 according to a size variation of the image frame projected by the projection device 124, so as to improve touch accuracy of the touch film 160.

It should be noted that the first coordinate transformation equation, the second coordinate transformation equation and the third coordinate transformation equation may be similar to the aforementioned equation (11) or equation (17). The processing device 140 of the embodiment may execute an operation method similar to that of the aforementioned equations (1)-(17) to generate the first coordinate transformation equation, the second coordinate transformation equation and the third coordinate transformation equation of the embodiment, and detail thereof is not repeated.

However, the correction method and the projection touch system of the invention are also adapted to the touch object 180 implemented by user's finger or a touch pen without a light source. Therefore, referring to FIG. 1, FIG. 3, FIG. 4 and FIG. 5, in an embodiment, the projection device 124 projects the image frame PI to the touch film 160. In the embodiment, the image frame PI may present the first correction image CI1 shown in FIG. 4, where the first correction image CI1 may include figures of 9 correction targets 401-409. In the embodiment, the touch film 160 may be attached on the non-planar surface S1, so that the first correction targets 401-409 of the first correction image CI1 may be distributed in regions of a plurality of planes on the touch film 160.

In the embodiment, the touch film 160 performs in response to a touch operation of the touch object 180 that touches the touch film 160 according to the first correction image CI1. Namely, the user may use the touch object 180 to sequentially touch or click positions of the correction targets 401-409 on the touch film 160, and the touch film 160 generates relative coordinate information to serve as the touch signal TS. Therefore, the processing device 140 may operate the coordinate information and the relative coordinate information according to the first correction image CI1 and the touch signal TS, and generate the first coordinate transformation equation. In the embodiment, the first coordinate transformation equation relates to coordinate transformation between the touch film 160 and the projection device 124.

In the embodiment, the projection device 124 projects the projection image PI to the touch film 160, where the image frame PI may present the second correction image CI2 shown in FIG. 5. The second correction image CI2 may include figures of 100 correction targets 501, though the number of the correction targets 501 is not limited by the invention. In the embodiment, the processing device 140 may capture the second correction image CI2 projected to the touch film 160 through the image capturing device 126, so as to obtain the captured image frame PI′. The processing device 140 may record the captured image frame PI′ to serve as the first image frame. In the embodiment, the processing device 140 may obtain the coordinate information of the positions of the correction targets 501 in the first image frame through image analysis. Namely, the processing device 140 may generate the second coordinate transformation equation according to the coordinate information respectively corresponding to the first image frame and the second correction image CI2. In the embodiment, the second coordinate transformation equation relates to coordinate transformation between the projection device 124 and the image capturing device 126.

In the embodiment, the processing device 140 may deduce the third coordinate transformation equation according to the first coordinate transformation equation and the second coordinate transformation equation. To be specific, since the first coordinate transformation equation relates to coordinate transformation between the touch film 160 and the projection device 124, and the second coordinate transformation equation relates to coordinate transformation between the projection device 124 and the image capturing device 126, the processing device 140 may combine or translate the first coordinate transformation equation and the second coordinate transformation equation to obtain the third coordinate transformation equation adapted to the coordinate transformation between the touch film 160 and the image capturing device 126.

Therefore, the processing device 140 of the embodiment may translate the coordinate information of the correction targets 501 through the third coordinate transformation equation, so as to obtain relative coordinate relationships of the correction targets 501 on the touch film 160. Namely, the processing device 140 of the embodiment may adopt the first coordinate transformation equation, the second coordinate transformation equation and the third coordinate transformation equation to perform a multi-point correction operation to the touch film 160. In other words, since the touch film 160 is probably attached on the non-planar surface S1, based on the relative coordinate relationships of the correction targets 501 on the touch film 160 and the coordinates of the correction targets 501 corresponding to the projection device 124 stored in the processing device 140, the processing device 140 may correspondingly correct the touch region of the touch film 160 according to a size variation of the image frame projected by the projection device 124, so as to improve touch accuracy of the touch film 160.

It should be noted that the first coordinate transformation equation, the second coordinate transformation equation and the third coordinate transformation equation may be similar to the aforementioned equation (11) or equation (17). The processing device 140 of the embodiment may execute the operation method similar to that of the aforementioned equations (1)-(17) to generate the first coordinate transformation equation, the second coordinate transformation equation and the third coordinate transformation equation of the embodiment, and detail thereof is not repeated.

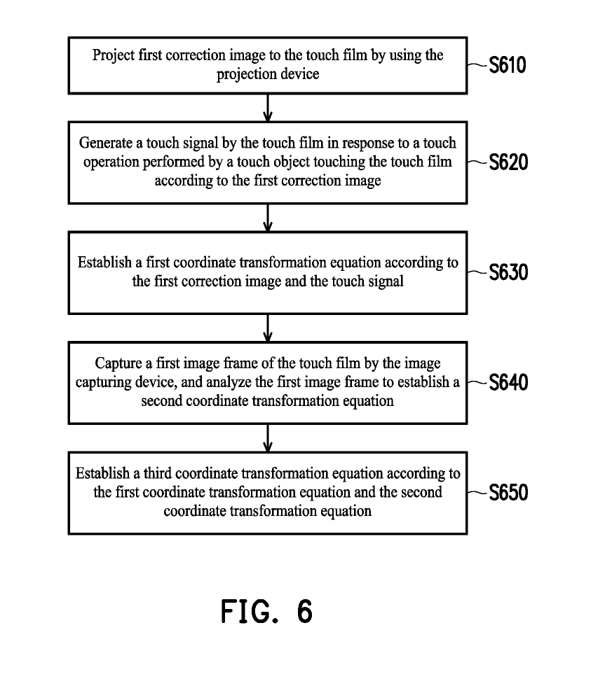

FIG. 6 is a flowchart illustrating a correction method according to an embodiment of the invention. Referring to FIG. 1, FIG. 2, FIG. 4 and FIG. 6, the correction method of the embodiment is adapted to the projection touch systems 100, 200. In step S610, the projection touch system 100 projects the first correction image CI1 to the touch film 160 by using the projection device 124. In step S620, the projection touch system 100 generates the touch signal TS through the touch film 160 in response to a touch operation performed by the touch object 180 for touching the touch film 160 according to the first correction image CI1. In step S630, the projection touch system 100 establishes the first coordinate transformation equation according to the first correction image CI1 and the touch signal TS. In step S640, the projection touch system 100 captures a first image frame of the touch film 160 by using the image capturing device 126, and analyzes the first image frame to establish the second coordinate transformation equation. In step S650, the projection touch system 100 establishes the third coordinate transformation equation according to the first coordinate transformation equation and the second coordinate transformation equation. Therefore, the projection touch system 100 of the invention may adopt the first coordinate transformation equation, the second coordinate transformation equation and the third coordinate transformation equation to perform the multi-point correction operation to the touch film 160.

In summary, the embodiments of the invention have at least one of the following advantages and effects. The touch film of the invention may be attached on a planar or non-planar surface. The projection touch system and the correction method of the invention may analyze the correction image projected by the projection device, and generate the touch signal through the touch film, and obtain the coordinate information through the image frame captured by the image capturing device and relative coordinate relationships of the coordinate information on the touch film. The projection touch system and the correction method of the invention mainly use the image capturing device, and respectively establish the first coordinate transformation equation, the second coordinate transformation equation and the third coordinate transformation equation between the touch film, the projection device and the image capturing device, such that the projection touch system may adopt these coordinate transformation equations to perform accurate and efficient multi-point correction operation to the touch film. Moreover, the projection touch system and the correction method of the invention are adapted to the touch object that includes a light source or without including the light source.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection touch system, comprising:
a processing device;
a touch film, coupled to the processing device;
a projection device, coupled to the processing device, and configured to project a first correction image to the touch film, wherein the touch film generates a touch signal in response to a touch operation performed by a touch object touching the touch film according to the first correction image; and
an image capturing device, coupled to the processing device, and configured to capture a first image frame on the touch film, wherein the processing device generates a first coordinate transformation equation according to the first correction image and the touch signal, and the processing device establishes a second coordinate transformation equation according to the first image frame, and the processing device establishes a third coordinate transformation equation according to the first coordinate transformation equation and the second coordinate transformation equation.

2. The projection touch system as claimed in claim 1, wherein the touch film is attached to a non-planar surface.

3. The projection touch system as claimed in claim 1, wherein the first correction image comprises a plurality of first correction targets, and the touch film generates the touch signal in response to a situation that the touch object touches a plurality of positions of the first correction targets in the first correction image sequentially.

4. The projection touch system as claimed in claim 3, wherein the touch film is attached to a non-planar surface, and the first correction targets of the first correction image are distributed in regions of a plurality of different planes of the touch film.

5. The projection touch system as claimed in claim 3, wherein the touch object comprises a light source, and the touch object emits light on the plurality of positions via the light source in response to the situation that the touch object touches the plurality of positions of the first correction targets in the first correction image,
wherein the processing device performs to capture a plurality of light spot images produced by the light source at the plurality of positions by using the image capturing device, and the processing device integrates the light spot images to obtain the first image frame.

6. The projection touch system as claimed in claim 5, wherein the processing device analyzes positions of a plurality of light spots in the first image frame, so as to establish the second coordinate transformation equation.

7. The projection touch system as claimed in claim 6, wherein the processing device performs to project a second correction image to the touch film by the projection device, and the second correction image comprises a plurality of second correction targets,
wherein the processing device performs to capture the second correction image projected to the touch film by using the image capturing device, so as to generate a second image frame,
wherein the processing device analyzes the second image frame to obtain coordinate information of the second correction targets, and the processing device translates the coordinate information through the third coordinate transformation equation, so as to obtain a relative coordinate relationship of the coordinate information on the touch film.

8. The projection touch system as claimed in claim 3, wherein the processing device performs to project a second correction image to the touch film by the projection device, and the second correction image comprises a plurality of correction targets,
wherein the processing device performs to capture the second correction image projected to the touch film by using the image capturing device, so as to generate the first image frame.

9. The projection touch system as claimed in claim 8, wherein the processing device analyzes coordinate information of the second correction targets in the first image frame to establish the second coordinate transformation equation.

10. A correction method, adapted to a projection touch system comprising a touch film, a projection device and an image capturing device, the correction method comprising:
projecting a first correction image to the touch film by using the projection device;
generating a touch signal by the touch film in response to a touch operation performed by a touch object touching the touch film according to the first correction image;
establishing a first coordinate transformation equation according to the first correction image and the touch signal;
capturing a first image frame of the touch film by the image capturing device, and analyzing the first image frame to establish a second coordinate transformation equation; and
establishing a third coordinate transformation equation according to the first coordinate transformation equation and the second coordinate transformation equation.

11. The correction method as claimed in claim 10, wherein the touch film is attached to a non-planar surface.

12. The correction method as claimed in claim 10, wherein the first correction image comprises a plurality of first correction targets, and the step of generating the touch signal by the touch film in response to the touch operation performed by the touch object touching the touch film according to the first correction image comprises:
generating the touch signal by the touch film in response to a situation that the touch object touches a plurality of positions of the first correction targets in the first correction image sequentially.

13. The correction method as claimed in claim 12, wherein the touch film is attached to a non-planar surface, and the first correction targets of the first correction image are distributed in regions of a plurality of different planes of the touch film.

14. The correction method as claimed in claim 12, wherein the touch object comprises a light source, and the step of capturing the first image frame of the touch film by the image capturing device comprises:
emitting light on the plurality of positions via the light source in response to the situation that the touch object touches the plurality of positions of the first correction targets in the first correction image; and
capturing a plurality of light spot images produced by the light source at the plurality of positions by using the image capturing device, and integrating the light spot images to obtain the first image frame.

15. The correction method as claimed in claim 14, wherein the step of analyzing the first image frame to establish the second coordinate transformation equation comprises:
analyzing positions of a plurality of light spots in the first image frame, so as to establish the second coordinate transformation equation.

16. The correction method as claimed in claim 15, further comprising:
projecting a second correction image to the touch film through the projection device, wherein the second correction image comprises a plurality of second correction targets;
capturing the second correction image projected to the touch film by using the image capturing device, so as to generate a second image frame; and
analyzing the second image frame to obtain coordinate information of the second correction targets, and translating the coordinate information through the third coordinate transformation equation, so as to obtain a relative coordinate relationship of the coordinate information on the touch film.

17. The correction method as claimed in claim 12, wherein the step of capturing the first image frame of the touch film by the image capturing device comprises:
projecting a second correction image to the touch film through the projection device, wherein the second correction image comprises a plurality of correction targets; and
capturing the second correction image projected to the touch film by using the image capturing device, so as to generate the first image frame.

18. The correction method as claimed in claim 17, wherein the step of analyzing the first image frame to establish the second coordinate transformation equation comprises:
analyzing coordinate information of the second correction targets in the first image frame to establish the second coordinate transformation equation.

19. The correction method as claimed in claim 18, further comprising:
translating the coordinate information through the third coordinate transformation equation, so as to obtain a relative coordinate relationship of the coordinate information on the touch film.
